(19) United States
(12) Patent Application Publication
(10) Pub. No.: US 2007/0209857 A1
(43) Pub. Date: Sep. 13, 2007

(54) Actuator

(76) Inventor: Erwin Wolf, Winnenden (DE)

Correspondence Address: GUDRUN E. HUCKETT DRAUDT, SCHUBERTSTR. 15A, WUPPERTAL, 42289, DE

(21) Appl. No.: 10/599,736

(22) PCT Filed: Apr. 8, 2005
(86) PCT No.: PCT/EP05/03716

§ 371 Date: Oct. 6, 2006

(30) Foreign Application Priority Data
Apr. 8, 2004 (DE) 10 2004 017 396.6
Aug. 21, 2004 (DE) 10 2004 040 602.2

(51) Int. Cl. B60K 26/00

(52) U.S. Cl. 180/315

(57) ABSTRACT

The invention relates to an actuator, in particular for components of a motor vehicle such as an electric seat adjuster or the like. The actuator comprises a drive motor (1) and a reduction gear (2). The reduction gear (2) comprises a housing (3), a wobble plate (4), a driven wheel (6) interacting by means of a toothing (5) with the wobble plate (4), and a guide device (7) for the wobble plate (4). By means of the guide device (7), the wobble plate (4) is substantially secured against rotation relative to the housing (3) and allowed to perform a wobbling movement on a circular path (8). The guide device (7) comprises a guide arm (52) that is formed in particular as a unitary part of the wobble plate (4) which guide arm by means of a radial guide (10) is slidable in a radial direction (9) relative to the circular path (8) and is essentially secured against rotation.

The invention relates to an actuator, in particular for components of a motor vehicle, such as an electric seat adjustor or the like, having the features according to the preamble of claim 1.

Actuators for movable components are subject to high requirements with regard to performance, robustness, and reliability while at the same time a minimal size is desired. In particular in the field of motor vehicles, actuators, for example, for an electric seat adjustor, are used wherein a seat back adjustment, seat height adjustment, and horizontal position adjustment are performed with different actuators. Appropriate high-performance drive motors are provided whose high drive speed must be reduced by a suitable reduction gear to an appropriate minimal output speed.

For providing a suitable high reduction gear that has a minimal size, a so-called wobble plate mechanism is used in which a wobble plate is essentially fixedly secured by means of a guide device relative to a gear housing so as to prevent rotation and is free to perform a wobbling movement on a circular path. By means of the drive motor, the wobble plate is moved on a circular path without the wobble plate itself being rotated. The wobble plate is provided with a gear wheel having an outer toothing that engages a ring gear having an inner toothing that is provided at the driven side. For a high reduction action, the inner toothing of the ring gear has only a minimally higher number of teeth than the gear wheel of the wobble plate. The rotatably supported driven wheel rolls on the wobble plate that is secured against rotation so that the rotational speed of the driven wheel is significantly smaller than the rotational speed of the wobble plate on its circular path.

For the reduced force transmission between the wobble plate and the driven wheel, it is necessary to guide the wobble plate such that a free lateral movability on a circular path is possible and, at the same time, a rotation of the wobble plate itself is prevented. Known configurations of such guide actions are complex with regard to their construction and they are mechanically susceptible to failure.

The invention has the object to further develop an actuator of the aforementioned kind such that a simplified and reliable guiding action of the wobble plate is provided.

This object is solved by an actuator having the features of claim 1.

An actuator with a wobble plate is proposed whose guiding device comprises a guide arm that is, in particular, formed as a monolithic part of the wobble plate. The guide arm is slidable by means of a radial guide in a radial direction relative to the circular path and is essentially secured to prevent rotation. The guide arm enables, depending on the configuration of its support, a pivotable or rotating movement of itself together with the wobble plate. At the same time, the guide arm prevents by means of its radial guide the rotation of the wobble plate itself. High-reduction rotational movements can be transmitted reliably and at high torque with a configuration that is simple with regard to construction and manufacturing technology.

In an advantageous further embodiment, an eccentric with an eccentrically circulating bearing pin is provided for driving the wobble plate which eccentric engages a particularly centrally arranged bearing opening of the wobble plate. This provides a uniform movement of the wobble plate on its circular path wherein the rotating support of the bearing pin in the bearing opening is highly loadable while being subject to minimal wear.

For driving the eccentric, a worm gear is advantageously provided. This provides a first high-reduction gear stage that requires only minimal space and is self-locking at the same time. The components to be moved can be adjusted with minimal force expenditure wherein the outer loads acting on the corresponding component, as a result of the self-locking action, do not lead to an automatic undesirable adjustment.

In an advantageous embodiment, the guide arm of the wobble plate is configured as a swivel arm whose radial outwardly positioned free end is supported on a swivel bearing of the radial guide. The free end of the swivel arm has expediently a rounded widened swivel head that is guided slidingly between two parallel walls of a radial groove fixed to the housing. In case of a driven movement of the wobble plate on a circular path, the rotation of the wobble plate itself is prevented by means of the swivel arm. At the same time, a lateral movability of the wobble plate in two directions that are perpendicular to one another in a plane of the circular path is possible. One free direction corresponds to the radial direction of the radial groove fixed to the housing while the free direction that is perpendicular thereto is determined by the swivel direction that is transverse to the radial direction. The movement of the wobble plate on its circular path is comprised of two components of which one is the radial movement and the other is the swivel movement transverse thereto. The swivel head serves as a swivel axis; the swivel head provides at the same time the radial guiding action in the radial groove. Only a single swivel arm is required that engages a corresponding radial groove fixed to the housing wherein the swivel head has a double function in that, in cooperation with the radial groove, it enables a wobbling circular movement of the wobble plate and, at the same time, prevents reliably rotation of the wobble plate itself. Additional guiding devices are not required. A reliable securing action against rotation is provided. The formation of friction pairs that are subject to wear is limited to the interaction of the swivel head with the groove walls. In this way, a kinematically simple, robust, and reliable configuration is provided that is highly loadable. In particular when used in a seat adjustor, a high load capacity in regard to, for example, accident-caused impact loads is provided; this contributes to the safety of the arrangement.

The essentially fixed securing action of the wobble plate in the radial guide and the swivel support acting transversely thereto effect a minimal oscillating rotational movement of the wobble plate about a stationary neutral position. It has been surprisingly found that its effect on the uniformness of the output speed for an appropriately long swivel arm is only minimal and can be essentially neglected. For further reduction of this effect it is expedient to provide an arrangement in which by means of the parallel walls of the radial groove a guide section is formed that is adjoined radially inwardly by a swivel section that widens inwardly. The guide section is positioned relative to the position of the wobble plate at a radially enlarged spacing. The swivel head of the appropriately elongated swivel arm, which swivel head is slidingly and pivotably guided in the guide section, causes a correspondingly enlarged swivel radius. The circular path movement of the wobble plate sets a swivel amplitude that effects a reduced amplitude of the wobbling rotation itself as a result of the enlarged swivel radius. The uniformness of the output speed is increased. The widening swivel section of the radial groove enables a free swivel movement without restricting the support cross-section of the swivel arm.

In an advantageous embodiment, the free end of the guide arm is forcibly guided on a circular path synchronously to the wobbling movement of the wobble plate on its circular path. The module comprised of guide arm and wobble plate is subjected to a circulating translatory parallel displacement without this causing a wobbling rotation of the module itself. A precisely uniform rotational transmission from the drive onto the driven side is possible.

For realizing the forced guiding action of the free end of the guide arm, it is expedient to provide an additional eccentric with an eccentrically circulating bearing pin that engages a bearing opening of the free end of the guide arm.

In an expedient embodiment, the two eccentrics are arranged on opposite sides of the worm gear position and are driven by it. Appropriate toothings of both eccentrics engage opposite points of the worm gear so that the worm gear and thus the module as a hole has only a minimal compact length.

In an advantageous alternative, the two eccentrics are arranged in a staggered arrangement relative to one another in the axial direction of the worm gear on the same side of the worm gear and are driven by it. Relative to a direction that is transverse to the axial direction of the drive worm, this provides a correspondingly reduced size. At the same time, it is ensured that both eccentrics have the same direction of rotation. The correlated bearing pins can engage without play corresponding circular bearing openings of the two eccentrics so that the transmission train is stiff and at the same time essentially free of wear. It can be advantageous in this connection to provide the wobble plate with a guide arm that extends in two radial directions that are opposed to one another, is provided with two opposed free ends and, in particular, is arranged approximately centrally between the two eccentrics. The two free ends of the guide arm are forcibly guided on the correlated eccentric, respectively. The circulating parallelogram guide of the guide arm and of the central wobble plate is ensured by the two outer eccentrics. This provides a highly loadable, symmetric force transmission that is thus free of a moment of tilt.

In an advantageous embodiment, on each of the two ends of the guide arm a wobble plate for driving a driven wheel is arranged, respectively. The two wobble plates that are connected to one another by means of the guide arm carry out together and synchronously a wobbling movement that is transmitted as a reduced rotation onto both driven wheels. By means of a single drive it is possible with only minimal added constructive expenditure to control synchronously two different movement courses by means of the two driven wheels. Rotational speed and reduction gear ratio of both driven sides can be predetermined independently from one another by selecting the appropriate toothings.

The eccentric is expediently rotatably supported on a continuous axle bolt that is in particular made from steel, wherein the eccentric bearing pin with regard to its diameter is sized such that the axle bolt lies within the circumferential contour of the eccentric bearing pin. The continuous configuration of the axle bolt enables its support at both ends. In comparison to a configuration supported only at one end, a significantly reduced bending load results. An increased load capacity is provided without the axle bolt positioned within the circumferential contour of the bearing pin hindering the bearing pin in carrying out an eccentric circulating movement along a circular path.

The bearing pin and in particular a monolithic configuration of the bearing pin together with the eccentric is advantageously manufactured from a self-lubricating plastic material wherein the bearing pin, in the area positioned in the direction of eccentricity, has a metal insert resting against the axle bolt. In cooperation with the metallic configuration of the wobble plate this provides a self-lubricating gliding pair with minimal friction and minimal wear. An impact load on the actuator, resulting from an accident, for example, is transmitted onto the eccentric wherein the metal insert prevents a radial deformation of the eccentric bearing pin. The wobble plate is reliably held on its eccentric path and thus retained in engagement with the inner toothing of the driven wheel. The force transmission between drive side and driven side is thus permanently ensured. For example, in connection with a seat adjustor an accidental position change of the seat as a result of impact load is prevented.

In an expedient further embodiment, the driven wheel is supported together with the eccentric on the axle bolt. A reliable positional fixation of both components relative to one another is provided that ensures even for high operating loads a reliable meshing of the toothings acting between the two components. In particular, the driven wheel has an external bearing surface by means of which the driven wheel is rotatably supported in the housing. The continuous axle bolt can be fixed to the housing at the drive side while on the oppositely positioned driven side an indirect support by means of the driven wheel and its bearing surface relative to the gear housing is provided. The axle bolt must not penetrate the driven wheel so that the driven wheel can act freely on any type of driven device. The indirect support of the end of the axle bolt at the driven side corresponds in its mechanical action however to a housing-fixed support with a correspondingly high load capacity. This provides a combined guiding action of the driven wheel with its bearing surface directly in the housing and also on the axle bolt. A high positional precision of the driven wheel relative to the housing and any type of driven device attached thereto as well as relative to the wobble plate is ensured. All movable components mesh reliably with one another.

The wobble plate has advantageously a gear wheel formed as a monolithic part and shaped, in particular, by means of stamping of a metal blank. A die that is shaped like a gear wheel is pressed into the metal blank so that the material flows into an appropriately shaped die plate having a gear wheel shape on the opposite side. The resulting outer toothing that is formed by the die plate can be manufactured with minimal expenditure and high precision.

In an advantageous further embodiment, fastenings screws, embodied in particular as collar screws, penetrate the reduction gear housing, made in particular from plastic material, across at least approximately its entire thickness and are provided for screw-connecting the housing to the component that is to be driven by the actuator. Expediently, the housing is comprised of a bottom part and a cover part wherein the fastening screws passed through the bottom part and the cover part. At least two of the fastenings screws are preferably arranged on a line that is positioned at an angle of at least approximately 45° relative to an axis of rotation of the drive motor or the drive worm wherein the driven wheel preferably is positioned between the two fastenings screws. Aside from the pure fastening function, the fastening screws also provide for stabilization of the gear housing. It has been surprisingly found that in particular for the afore described 45° arrangement of the fastenings screws the gain with regard to housing stability is especially significant. The housing or its bottom part and cover part can be manufactured from plastic material inexpensively and so as to have minimal weight. Occurring extraordinary operational loads caused by crash and impact loads, for example, of a seat adjustor or the like, that are transmitted from the module to be driven onto the driven side and from there onto the reduction gear, can be received reliably by the gear housing. Bursting of the housing under extreme load is prevented.

One embodiment of the invention will be explained in the following in detail with the aid of the drawing. It is shown in:

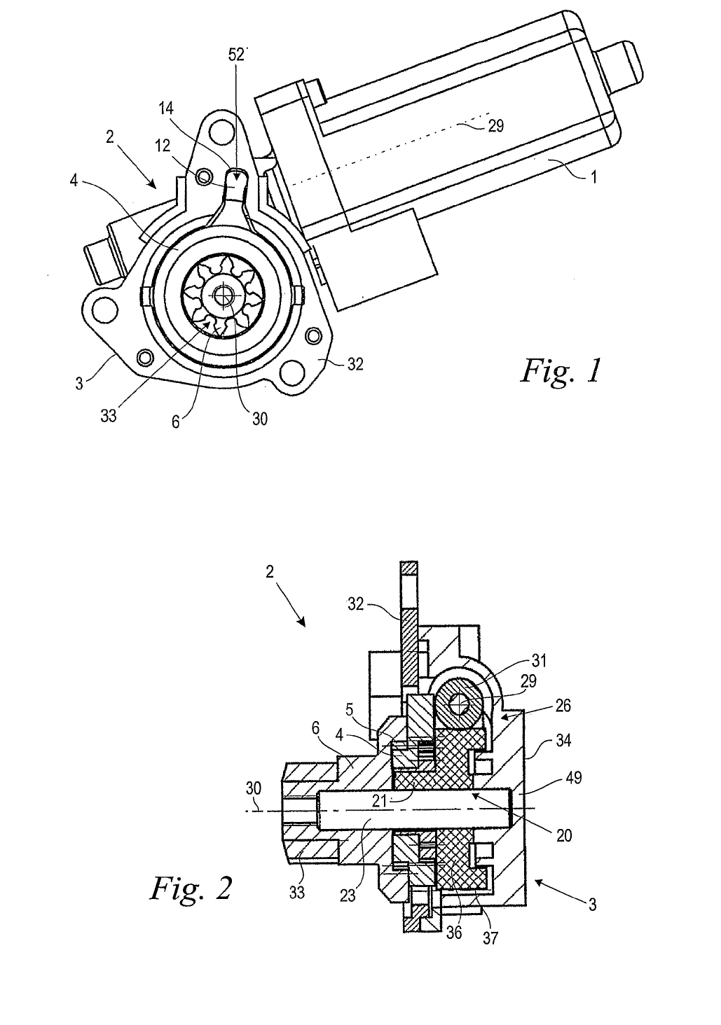

FIG. 1 an actuator with electric drive motor and partially open gear in an overview illustration;

FIG. 2 a section illustration of the reduction gear according to FIG. 1;

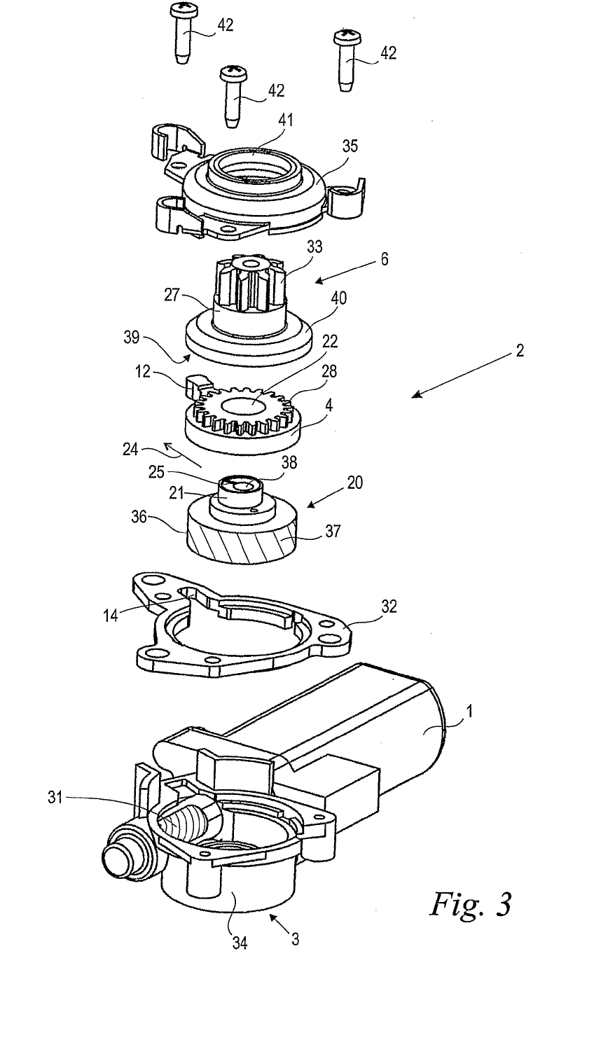

FIG. 3 a perspective exploded view of the actuator of FIG. 1 with details of the individual gear components according to FIG. 2;

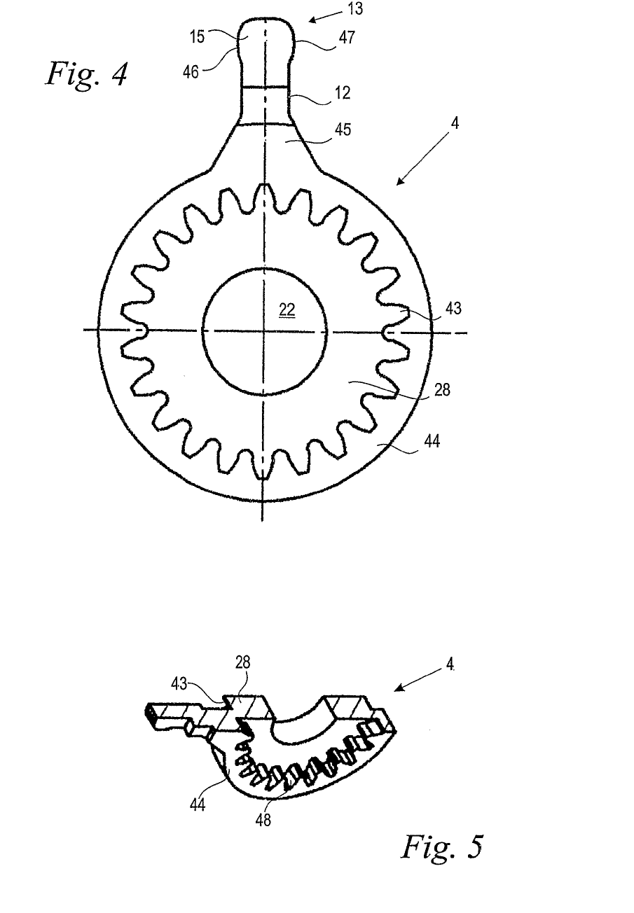

FIG. 4 an enlarged plan view of the wobble plate according to FIG. 3;

FIG. 5 a perspective partially sectioned illustration of the wobble plate according to FIG. 4 with details of a stamped gear wheel;

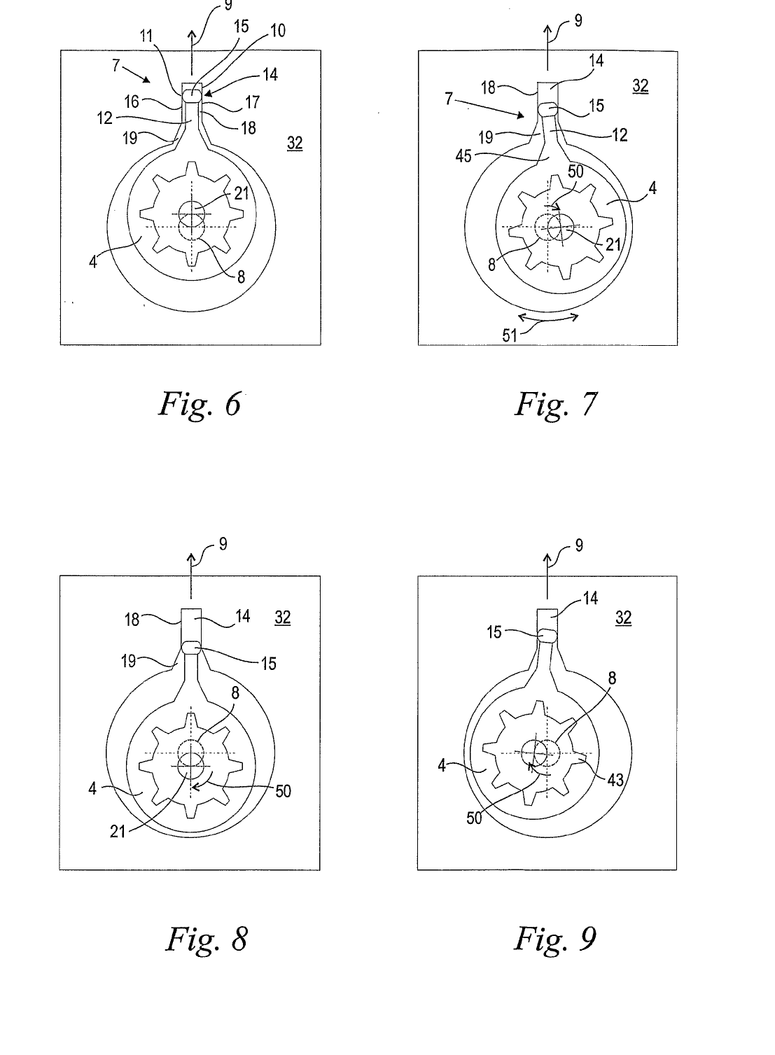

FIG. 6 a schematic basic illustration of the anti-rotation guiding of the wobble plate on a circular path;

FIG. 7 a phase illustration of the arrangement of FIG. 6 with swivelled and radially moved wobble plate;

FIG. 8 a further phase illustration of the arrangement of FIGS. 6 and 7 upon completion of half a circular path movement;

FIG. 9 a final phase illustration of the movement of the wobble plate of the arrangement according to FIG. 6 through 8 with almost completed circular path movement;

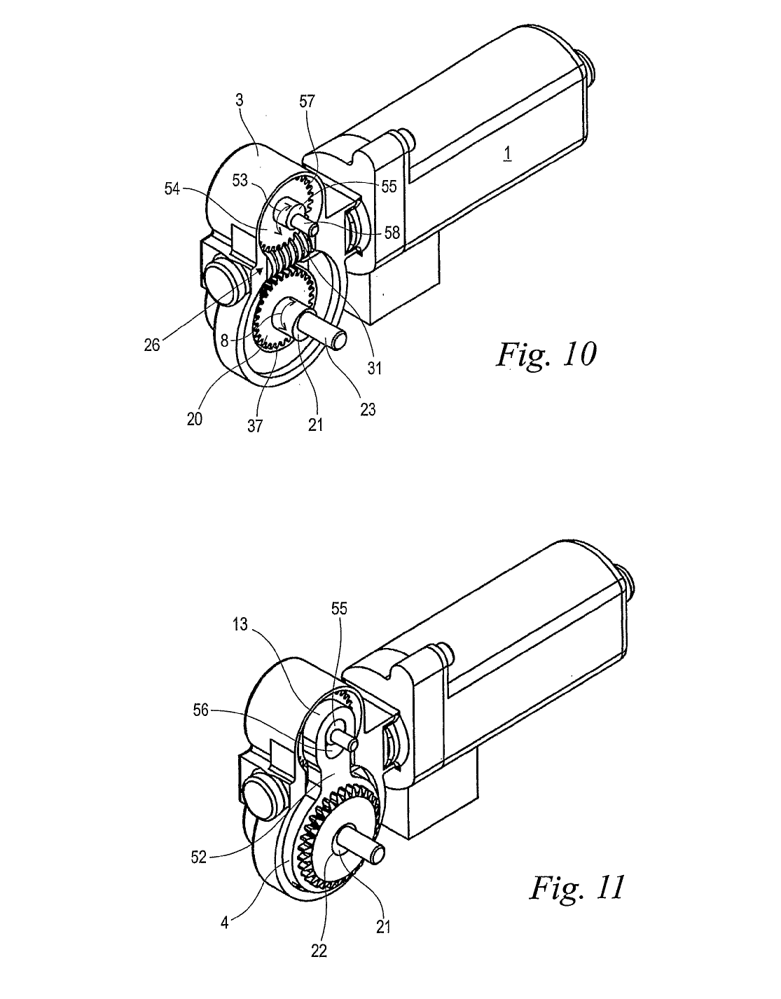

FIG. 10 a perspective view of a variant of the arrangement according to FIGS. 1 through 9 in partially demounted state with two eccentrics that are positioned opposite one another relative to the drive gear;

FIG. 11 the arrangement according to FIG. 10 with mounted wobble plate guided on both eccentrics;

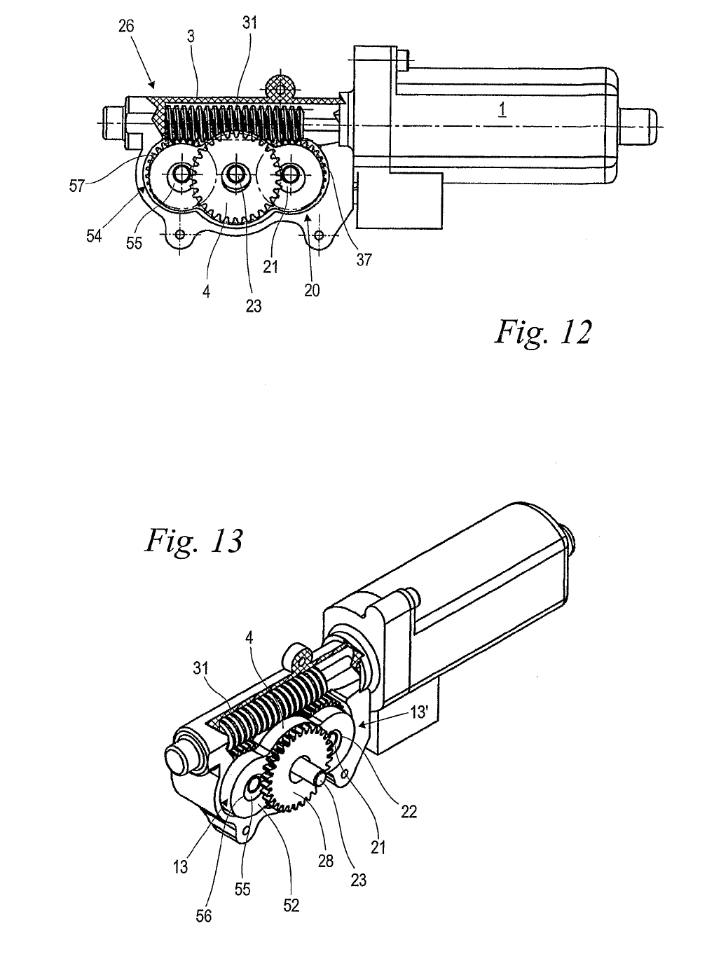

FIG. 12 a partially sectioned side view of a variant of the arrangement according to FIGS. 10 and 11 with two eccentrics that are arranged on the same side relative to the drive worm;

FIG. 13 a perspective illustration of the arrangement according to FIG. 12 with details of the mounted wobble plate and its guide arm with two ends;

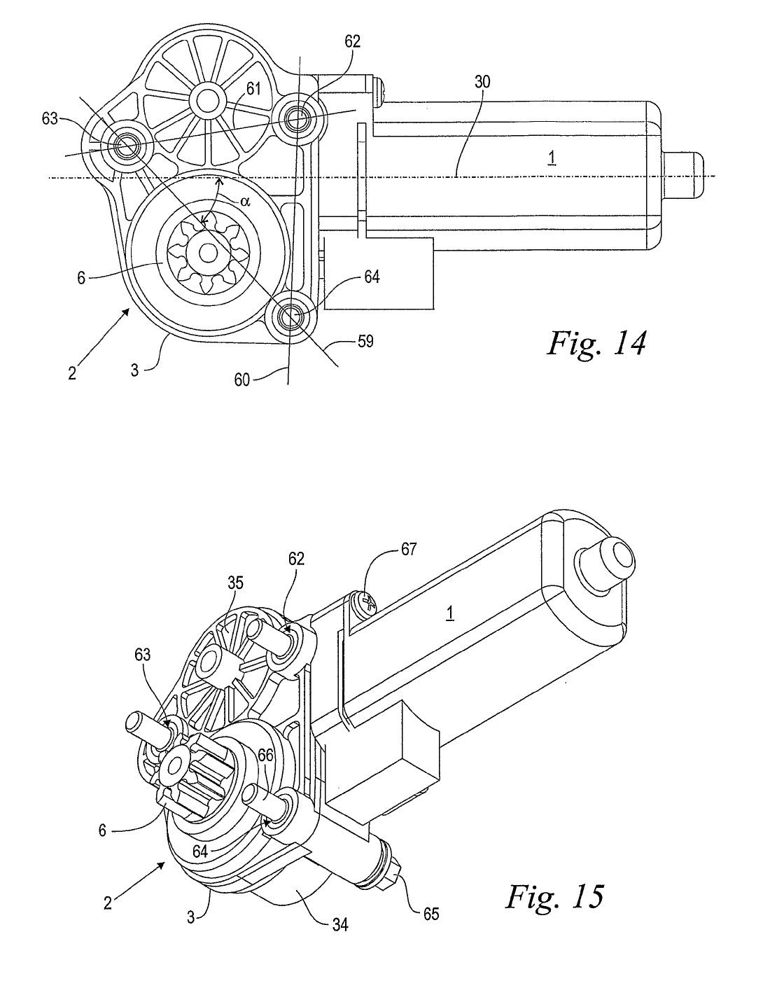

FIG. 14 a plan view onto the embodiment according to FIGS. 10 and 11 with screw holes in the gear housing for fastenings screws penetrating it;

FIG. 15 a perspective view of the arrangement according to FIG. 14 with penetrating fastening screws;

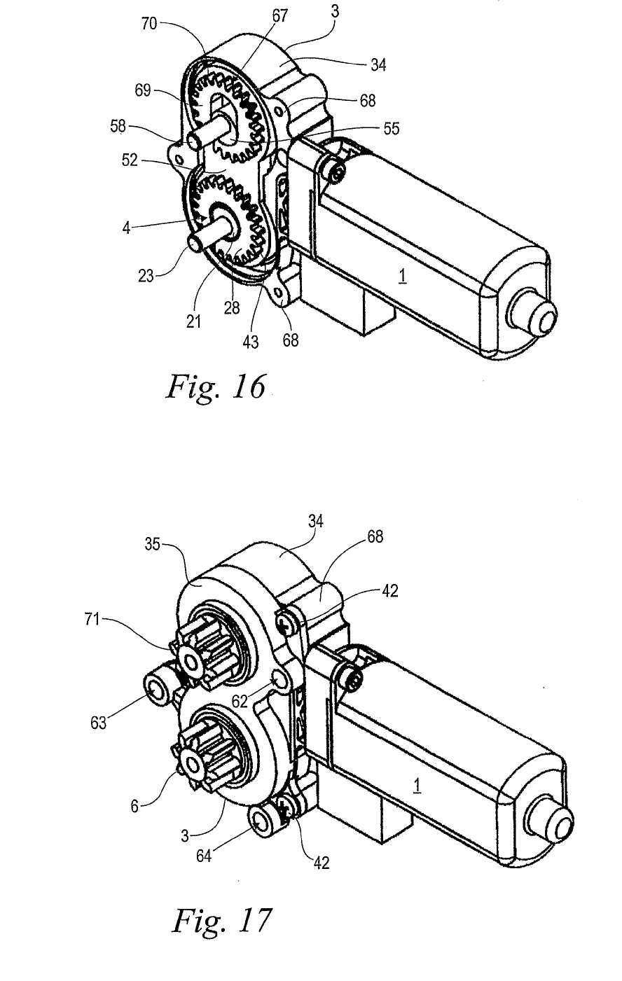

FIG. 16 a perspective illustration of an embodiment with open gear housing and two wobble plates;

FIG. 17 the arrangement according to FIG. 16 with two mounted driven wheels.

FIG. 1 shows in a schematic overview illustration an actuator for an electric seat adjustor of a motor vehicle. The illustrated actuator can advantageously be provided also for electric power windows, a convertible top actuator or for similar applications. The actuator comprises an electric drive motor 1 and a reduction gear 2 with a driven wheel 6. A housing 3 of the reduction gear 2 is flanged to the drive motor 1. By means of the reduction gear 2 a fast drive rotation of the drive motor about an axis of rotation 29 is converted into a reduced slow rotational movement of the driven wheel 6. In this connection, the driven wheel 6 rotates about an axis of rotation 30 that is positioned at a right angle and axially displaced relative to the axis of rotation 29 of the drive motor 1. The driven wheel 6 is embodied as a gear wheel 33 that engages a driven device, not illustrated in detail, in the form of a toothed rack of the like, for example. For clarity of illustration, the housing 3 is shown with removed cover part 35 according to FIG. 3. The illustration shows that the wobble plate 4 is provided with a guide arm 52 that is formed as a unitary part of the wobble plate 4 in the illustrated embodiment. The guide arm 52 is configured as a swivel arm 12 and engages a radial groove 14. The radial groove 14 is formed in an intermediate plate 32 of the housing 3.

FIG. 2 shows in a section view the reduction gear 2 according to FIG. 1. The bottom part 34 of the housing 3 is shown and also the intermediate plate 32 resting thereon. On the bottom part 34 of the housing 3 an axle bolt 23 is secured. In the illustrated embodiment, the axle bolt 23 is pressed into a rear wall 49 of the housing 3. The axle bolt 23 can also be screwed in or can be attached in any other way. An eccentric 20 and the driven wheel 6 with its gear wheel 33 provided at the end face are rotatably supported on the axle bolt 23. It can also be expedient to secure the axle bolt 23 fixedly in the driven wheel 6 or in the eccentric 20 wherein a relative rotation between axle bolt 23 and the remaining additional components is provided.

For driving the eccentric 20, a worm gear 26 is provided comprising a drive worm 31 and a spur wheel 36. The drive worm 31 is rotatable about the axis of rotation 29 of the drive motor 1 (FIG. 1) and meshes with the spur gear toothing 37 of the spur wheel 36. By rotating the drive worm 31, the spur wheel 36 is moved in rotation about axle bolt 23 having axis of rotation 30.

A bearing pin 21 is formed as a monolithic part of the spur wheel 36 from self-lubricating plastic material wherein the bearing pin 21 relative to the axis of rotation 30 is arranged eccentrically to the spur wheel 36. In this way, the eccentric 20 is created. The diameter of the bearing pin 21 is such that the axle bolt 23 is positioned within the circumferential contour of the eccentric bearing pin 21 and, in this connection, extends from the rear wall 49 of the housing 3 through the eccentric 20 into the driven wheel 6.

The bearing pin 21 of the eccentric 20 engages a bearing opening 22 of the wobble plate 40 which opening is illustrated in FIG. 3. By rotation of the eccentric 20 the wobble plate 4 is moved along a circular path 8 illustrated in FIGS. 6 through 9, wherein a rotation of the wobble plate 4 itself is prevented by the swivel arm 12 and the radial groove 14 (FIG. 1).

The wobble plate 4 interacts by means of its toothing 5 with the driven wheel 6 wherein a rolling movement of the driven wheel 6 in the toothing 5 relative to the wobble plate 4, essentially secured against rotation, provides a speed reduction such that the rotational speed of the driven wheel 6 relative to the speed of the eccentric 20 or the circulating speed of the wobble plate 4 is reduced. In this way, a two-stage self-locking reduction gear is provided wherein a first self-locking reduction gear stage is provided by the worm gear 26 and a second reduction gear stage is provided by interaction of the wobble plate 4 with the driven wheel 6.

FIG. 3 shows in a perspective exploded view the actuator according to FIG. 1 with details of the individual parts of the reduction gear 2 according to FIG. 2. The housing 3 of the reduction gear 2 comprises the bottom part 34 flanged to the drive motor 1 and provided with rear wall 49 (FIG. 2). Additional parts of the housing 3 are the intermediate plate 32 with radial groove 14 and the cover part 35. The cover part 35 is screw-connected with interposition of the intermediate plate 32 by means of screws 42 to the bottom part 34.

Radially outside of the bottom part 34 the drive worm 31 is arranged which is provided for meshing with the spur gear toothing 37 of the spur wheel 36 of the eccentric 20. The eccentric 20 has an axial opening 38 centrally arranged relative to the spur wheel 36 by means of which the eccentric 20 is rotatably supported on the axle bolt 23 (FIG. 2). The bearing pin 21 of the eccentric 20 is in a displaced position relative to the central axial opening 38 by an eccentricity indicated by arrow 24. Into the bearing pin 21 that is manufactured from plastic material, a metal insert 25 is inserted, or embedded by injection-molding, in the direction of the eccentricity. The metal insert 25 is in the form of a small steel plate that extends in the axial direction across the entire length of the bearing pin 21 and in the radial direction extends from the inner surface of the axial opening 38 to the outer surface of the bearing pin 21. An embodiment can be expedient in which the metal insert 25 extends only across a portion of the bearing pin 21 in its axial direction.

The eccentric bearing pin 21 engages the central bearing opening 22 of the wobble plate 4. Operating loads that act between the wobble plate 4 and the eccentric 20 are supported by the bearing opening 22 by means of the metal insert 25 in the direction of eccentricity 24 on the axle bolt 23 (FIG. 2). The illustrated perspective illustration of the eccentric 20 also shows that the circumferential contour of the bearing pin 21 completely surrounds the axial opening 38 and thus the axial bolt 23 (FIG. 2).

The wobble plate 4 is essentially secured against rotation by means of the swivel arm 12 engaging the radial groove 14 of the intermediate pate 23 wherein however radial and swivel movements of the wobble plate 4 are possible in such a way that the eccentric circulating movement of the bearing pin 21, because of its engagement of the central bearing opening 22 of the wobble plate 4, leads to a circular path movement, illustrated in detail in FIGS. 6 through 9, without the wobble plate 4 itself being rotated. At the end face of the wobble plate 4 a gear wheel 28 is provided as a unitary part.

The driven wheel 6 has on the side facing the wobble plate 4 a cup 40 with an inner toothing 39, not illustrated in detail. The gear wheel 28 of the wobble plate 4 has a smaller diameter and a lower number of teeth than the toothing 39 of the driven wheel 6. The eccentric position of the bearing pin 21 of the eccentric 20 results in the same eccentric position of the gear wheel 28 of the wobble plate 4 so that the gear wheel 28 meshes with the inner toothing 39 of the driven wheel 6. As a result of the circular path movement of the wobble plate 4 according to FIGS. 6 through 9 without rotation of the wobble plate 4 itself, the inner toothing 39 of the driven wheel 6 rolls on the gear wheel 28 of the wobble plate 4. In this way, a reduced rotational movement of the driven wheel 6 relative to the driving speed of the eccentric 20 results.

Between the gear wheel 33 and the cup 40 the driven wheel 6 is provided with a circumferential bearing surface 27. In the mounted state, the gear wheel 33 penetrates a bearing opening 41 of the cover part 35 wherein the bearing surface 27 is slidingly supported in the bearing opening 41 without play. Instead of a sliding bearing action it is also possible to provide a rolling bearing action. The free end of the axle bolt 23 that, in accordance with FIG. 2, is secured in an inner blind bore of the driven wheel 6 is supported indirectly by means of the bearing surface 27 on the bearing opening 41 of the cover part 35. The axle bolt 23 is thus supported with both ends: in the area of the cover part 35 and, according to FIG. 2, with its opposite end in the area of the rear wall 49 of the housing 3.

Details of the wobble plate 4 can be seen in the enlarged illustration of FIG. 4. The wobble plate 4 is formed by a circular disk-shaped base member 44 from which projects radially outwardly the swivel arm 12. The swivel arm 12 and the base member 44 are formed as a unitary part, wherein the swivel arm 12 has a transition by means of an widened area 45 into the base member 44. At its free end 13, the swivel arm 12 has a widened swivel head 15 that projects laterally past the contour of the swivel arm 12. The widened, laterally projecting area of the swivel head 15 is formed by flanks 46, 47 that are formed as sections of a common circle. The circular disk-shaped base member 44, the unitary gear wheel 28 with its outer toothing 43, and the bearing opening 22 are arranged concentrically to one another. FIG. 5 shows in a perspective partially cross-sectional illustration the wobble plate 4 according to FIG. 4. The unitary wobble plate 4 is shaped from a sheet steel blank; the unitary gear wheel 28 is formed by stamping of the sheet metal blank. For this purpose, in the base member 44 an inner toothing 48 is stamped that is formed on the opposite side as a correspondingly shaped outer toothing 43 of the gear wheel 28. The shown inner toothing 48 is without importance for the function of the gear arrangement according to the invention but enables in a simple way the manufacture of the outer toothing 43.

In FIGS. 6 through 9 the course of movement of the wobble plate 4 is illustrated in sequential phase views.

FIG. 6 shows in a schematic block illustration the intermediate plate 32 with the radial groove 14 fixed to the housing. The inserted wobble plate 4 is substantially secured against rotation relative to the intermediate plate 32 by means of a guide device 7 but can move on the circular path 8 for performing a wobbling movement. The guide device 7 comprises a radial guide 10 acting in the radial direction 9 relative to the circular path 8 and combines with it a swivel support 11 of the wobble plate 4 acting transversely to the radial direction 9. The combination of radial guide 10 and swivel support 11 is formed in that the swivel head 15 of the swivel arm 12 engages the radial groove 14. In this connection, the swivel head 15 is guided in a sliding and pivotable way between two parallel walls 16, 17 of the radial groove 14. The parallel walls 16, 17 of the radial groove 14 form a guide section 18 of the radial groove 14 that is adjoined radially inwardly by a swivel section 19 that widens inwardly.

The bearing pin 21 is positioned in the illustrated view on the circular path 8 eccentrically in the direction of the radial groove 14. The swivel head 15 has penetrated as much as possible into the guide section 18.

According to FIG. 7, the bearing pin 21 is moved in the direction of arrow 50 on the circular path 8 by a quarter rotation. Together with the bearing pin 21 the wobble plate 4 has performed the same movement on the circular path 8. The circular path movement of the wobble plate 4 as a result of the eccentric circular movement of the bearing pin 21 is enabled by the guide device 7 in that the swivel head 15 allows for a linear radial movement counter to the radial direction 9 and, transversely thereto, a corresponding swivel movement in the direction of double arrow 51. By means of the swivel arm 12 engaging the radial groove 14 the rotation of the wobble plate 4 itself is essentially hindered wherein only a minimal oscillating rotation of the wobble plate 4 itself about the rest position illustrated in FIG. 6 will result because of the swivel movement 51. The widened swivel section 19 allows the swivel movement of the swivel arm 12.

FIG. 8 shows as a further phase view the arrangement according to FIGS. 6 and 7 in which the bearing pin 21 has been moved in rotational direction 50 to such an extent that the wobble plate 4 is in its lower position. The swivel head 15 has been moved downwardly in the radial groove 14 counter to arrow 9 to such an extent that it is positioned in the lower area of the guide section 18. By a further rotation in the direction of arrow 50 according to FIG. 9, the swivel head 15 moves again in the direction of arrow 9 in the radial groove 14 wherein the wobble plate 4 performs a swivel movement about the swivel head 15.

As a whole, the swivel movement of the wobble plate 4 in connection with the combined radial movement perpendicular thereto causes a movement on the circular path 8 wherein the gear wheel 43 itself carries out no rotational movement. The gear wheel 43 that is moved on the circular path 8 without itself being rotated forms together with inner toothing 39 of the driven wheel 6 (FIG. 3) the toothing 5 (FIG. 2) for reduced driving of the driven wheel 6.

FIG. 10 shows in a perspective view one embodiment variant of the actuator according to FIGS. 1 through 9 in partially demounted state. In the housing 3 that is flanged onto the drive motor 1, the worm gear 26 with drive worm 31 is arranged. In the illustrated embodiment, the eccentric 20 is positioned below the drive worm 31 while another eccentric 54 is arranged on the opposite side of the drive worm 31 or of the worm gear 26. The two eccentrics 20, 54 are rotatably supported on axle bolts 23, 58 in the housing 3. The bearing action on the axle bolts 23, 58 can be realized in accordance with the illustration of FIG. 2. It can also be expedient to form the axle bolts 23, 58 as a unitary part of the eccentric 20, 54 or to press them into the eccentric and to support them rotatably in the housing 3. The eccentrics 20, 54 engage with their spur gear toothing 37, 57 the drive worm 31. Both spur gear toothings 37, 57 have the same number of teeth so that as a result thereof they rotate under the action of the rotating drive worm 31 in opposite directions at the same rotational speed. The lower eccentric 54 is provided with an eccentrically arranged bearing pin 55 that moves in the driven state on a circular path 53 about the axis of the axle bolt 58. The bearing pin 21 moves in opposite direction thereto on its circular path 8 about the axis of the axle bolt 23. Both circular paths 8, 53 have the same diameter. The bearing pin 55 is aligned relative to the bearing pin 21 of the upper eccentric 20 in such a way that they carry out on their respective circular paths 8, 53 a synchronous opposite movement component perpendicular to the longitudinal axis of the drive worm 31 and a synchronous movement component of same orientation in the axial direction of the drive worm 31.

In FIG. 11 the arrangement according to FIG. 10 is illustrated with mounted wobble plate 4 wherein the wobble plate 4 has a unitary guide arm 52. The wobble plate 4 is supported on the bearing pin 21 by means of bearing opening 22 as disclosed in connection with FIGS. 1 through 9. The free end of the guide arm 52 is provided with a bearing opening 56 that is a slotted hole in the illustrated embodiment. The longitudinal axis of the bearing hole extends in the longitudinal direction of the guide arm 52. The bearing pin 55 engages the bearing opening 56 such that it is at least approximately without play transversely to the longitudinal extension of the slotted hole and is guided slidingly in the longitudinal direction.

For the above described synchronous rotational movement of the two bearing pins 21, 55 the module comprised of the wobble plate 4 and the guide arm 52 performs a parallel displaced movement in accordance with the circular path 8 (FIG. 10). In this way, a forced guiding action of the free end 13 of the guide arm 52 on a circular path synchronous to the wobbling movement of the wobble plate 4 on its circular path 8 is created. The module comprised of wobble plate 4 and guide arm 52 is not itself subject to rotation. The parallel displaced circular movement is transmitted onto the driven side in the way described in more detail in connection with FIGS. 1 through 9.

FIG. 12 shows in a partially sectioned side view a variant of the arrangement according to FIGS. 10 and 11 in which the eccentric 20 as well as an additional eccentric 54 are arranged on the same side of the worm gear 26 displaced relative to one another and are driven by the worm gear. The wobble plate 4 is centrally arranged between the two outer eccentrics 20, 54. The two eccentrics 20, 54 are provided on their outer side with a spur gear toothing 37, 57 engaging the drive worm 31 of the worm gear 26. As a result of their identical number of teeth and their arrangement on the same side relative to the drive worm 31, the eccentrics are driven synchronously to one another at same rotational speed and in the same direction. Their two bearing pins 21, 55 are aligned relative to one another such that they perform phase-identical movements on circular paths 8, 53 (FIG. 10).

The wobble plate 4 is pushed onto the bearing pins 21, 55 with the double-ended guide arm 52. A central opening of the wobble plate 4 is sized such that it engages the axle bolt 23 with play. The axle bolt 23 does not provide a bearing function for the wobble plate 4 but for the driven wheel 6 to be mounted in accordance with FIG. 2.

Details for arranging the wobble plate 4 are shown in the perspective illustration according to FIG. 13. The wobble plate 4 is designed as a monolithic part together with the guide arm 52 that, in the illustrated embodiment, has two free ends 13, 13′ extending in opposite radial directions and parallel to the drive worm 31. The two free ends 13, 13′ each have a bearing opening 22, 56 in the form of a cylindrical bore engaged by the two bearing pins 21, 55 without play. By rotation of the drive worm 31 by means of drive motor 1 the two eccentrics 20, 54 are subjected to phase-identical, synchronous rotation in the same direction. The circular path movement of the corresponding eccentric bearing pins 21, 55 leads to a translatory parallel displacement of the guide arm 52 and of the wobble plate 4 centrally arranged thereon on corresponding circular paths 8, 53 (FIG. 10). The gear wheel 28, formed as a unitary part of the wobble plate 4, transmits in this connection its circular path movement—free of rotation of the wobble plate—in the direction of the driven side in the way disclosed in connection with FIGS. 1 to 9.

Both eccentrics 20, 54 according to FIGS. 10 through 13 can be identical metal parts or can be made by injection molding from plastic material. A configuration is particularly expedient in which the eccentric 54 subject to low loads is made from plastic material and the eccentric 20 at the driven side subject to high loads is made from metal. In regard to the other features and reference numerals, the embodiment according to FIGS. 10 to 13 are identical relative to one another and identical to the embodiment of FIGS. 1 through 9.

FIG. 14 shows in a plan view a variant of the embodiment according to FIGS. 10 and 11 in which the housing 3 of the reduction gear 2 has a total of three screw holes 62, 63, 64. The screw holes 62, 63, 64 are arranged axis-parallel to the axis of rotation of the driven wheel 6 and penetrate completely the housing 3 in its entire thickness. For defining the position of the screw holes 62, 63, 64, in the illustration according to FIG. 14 lines 59, 60, 61 are placed through their center points. The two screw holes 63, 64 are connected to one another by the line 59 which is positioned at an angle a of approximately 45° to the axis of rotation 30 of the drive motor 1 or the drive worm 31 (FIG. 10). The driven wheel 6 is arranged approximately centrally between the two screw holes 63, 64 wherein its axis of rotation is spaced at minimal spacing from the line 59. The two screw holes 62, 64 are arranged relative to one another such that the connecting line 60 connecting them is positioned approximately at a right angle to the axis of rotation 30 and is positioned so as to neighbor the end face of the drive motor 1. The line 61 that extends through the two screw holes 62, 63 extends approximately parallel to the axis of rotation 30, i.e., at an angle of approximately 0°. For the aforementioned angle values a tolerance range of preferably +10° and in particular ±5° applies.

The arrangement according to FIG. 14 is shown in a perspective illustration in FIG. 15 showing that the housing 3 is comprised of a bottom part 34 and a cover part 35 that are manufactured both from plastic material. The housing 3 of the reduction gear 2 is screwed by means of screws 67 to the drive motor 1. The bottom part 34 and the cover part 35 can be loosely inserted into one another, can be snapped on, glued, welded or screwed together so that the actuator is formed as a preassembled module.

For fastening the actuator on a component to be driven by the actuator—for example, a motor vehicle seat adjuster or the like—a total of three fastening screws 65 are provided that are pushed through the corresponding screw holes 62, 63, 64. The perspective illustration according to FIG. 15 shows that the screw holes 62, 63, 64 extend through cylindrical, formed portions of the housing 3 whose length at least approximately corresponds to the thickness of the housing 3 measured in the axial direction of the fastening screws 65. The fastening screws 65 are configured as collar screws that have a smooth cylindrical collar without thread in the area of the screw holes 62, 63, 64. The cylindrical collar is positioned without play or with only minimal play in the respective screw holes 62, 63, 64. The fastening screws 65 are provided only at their free projecting ends with a threaded section 66, respectively. By means of the cylindrical smooth collar of the fastening screws 65, the bottom part 34 and the cover part 35 are aligned with one another relative to the separation plane between the two parts and are secured against displacement. An axial clamping action of the bottom part 34 and of the cover part 35 is realized together with the screw connection of the actuator with the component to be driven by it in that the threaded sections 66 are screwed into corresponding inner threads of this component. The illustrated preassembled actuator receives under the effect of the tightened fastening screws 65 its constructively provided final strength in the area of the housing 3. A comparable screw connection can also be expedient for a single-part housing configuration and/or in housings made from metal or other materials. In regard to other features and reference numerals, the embodiment of FIGS. 14 and 15 is identical to that of FIGS. 10 and 11.

A further variant of the actuator is illustrated in FIG. 16 wherein, for clarity of illustration, only the bottom part 34 of the housing 3 is shown. The arrangement corresponds to that of FIG. 11 wherein however on both ends of the guide arm 52 a wobble plate 4, 67 is arranged. The two wobble plates 4, 67 that are unitarily connected to one another by means of the guide arm 52 rotate about the two bearing pins 21, 55 in a way comparable to the embodiment of FIG. 11 and together carry out a synchronous circular wobbling movement without rotating themselves. The two wobble plates 4, 67 are provided with identical gear wheels 28, 69 whose outer toothings 43, 70 have the same number of teeth.

FIG. 17 shows the arrangement according to FIG. 16 in the finish-mounted state. On the two axle bolts 23, 58 illustrated in FIG. 16 identical driven wheels 6, 71 are mounted that correspond with regard to their configuration to the driven wheels 6 of the embodiments discussed above. In operation of the drive motor 1, the two driven wheels 6, 71 carry out a rotation in the same direction at reduced and identical speed. It can also be expedient to provide the outer toothings 43, 70 (FIG. 16) with a different number of teeth so that different rotational speeds of the two driven wheels 6, 71 result. Additionally or as an alternative, it can also be expedient to provide the two driven wheels 6, 71 with a toothing at the driven side having a different number of teeth. Downstream of the driven wheels 6, 71 a coupling can be arranged, respectively. In this way, in addition to a synchronous driving action of two components it is also possible to provide an individual independent control.

The cover part 35 illustrated in FIG. 17 in the mounted state is screwed on by means of self-tapping screws 42 to the bottom part 34 wherein the self-tapping screws 42 are screwed into bores of smaller size in corresponding screw receptacles 68 (FIG. 16) of the bottom part 34. The screw connection by means of screws 42 generates a preassembled module. For obtaining the final constructively provided strength, the housing 3 has screw holes 62, 63, 64 that are provided for receiving fastening screws 65 in accordance with the embodiment of FIG. 14 and FIG. 15. The position and configuration of this screw connection corresponds to the aforementioned embodiment. It is also possible to have a relative position of screws 62, 63 to the driven wheel 71 or to the axis of rotation 30 (FIG. 14) that is configured in analogy or optionally mirror-symmetrical to the arrangement of the screw holes 63, 64 according to FIG. 14. In regard to other features and reference numerals, the embodiment of FIGS. 16 and 17 is identical to that of the other embodiments.

What is claimed is:

1.-21. (canceled)

22. An actuator comprising:
a drive motor;
a reduction gear connected to the drive motor and comprising a housing, a first wobble plate, a first driven wheel having a toothing interacting with the first wobble plate, and a guide device for the first wobble plate;
wherein the first wobble plate is secured by the guide device against rotation relative to the housing and is able to move on a circular path for performing a wobbling movement;
wherein the guide device comprises a guide arm and a radial guide;
wherein the guide arm is connected to the first wobble plate and the first wobble plate and the guide arm form a unitary part;
wherein the guide arm is secured by the radial guide so as to be slidable in a radial direction relative to the circular path and so as to be essentially unable to rotate.

23. The actuator according to claim 22, further comprising a first eccentric that drives the first wobble plate, wherein the first eccentric comprises an eccentrically circulating bearing pin that engages a bearing opening of the first wobble plate.

24. The actuator according to claim 23, further comprising a worm gear that is connected to the drive motor and drives the first eccentric.

25. The actuator according to claim 24, wherein the guide arm of the first wobble plate is a swivel arm having a radially outwardly positioned free end that is supported on a swivel support of the radial guide.

26. The actuator according to claim 25, wherein the free end of the swivel arm engages a radial groove of the housing.

27. The actuator according to claim 26, wherein the free end of the swivel arm has a rounded swivel head that is guided slidingly between two parallel walls of the radial groove.

28. The actuator according to claim 27, wherein the two parallel walls of the radial groove form a guide section, wherein the housing has a swivel section that adjoins radially inwardly the guide section and widens inwardly beginning at the guide section.

29. The actuator according to claim 25, wherein the free end of the guide arm is forcibly guided on a circular path synchronously to the wobbling movement carried out by of the first wobble plate on the circular path.

30. The actuator according to claim 29, further comprising a second eccentric having an eccentrically circulating bearing pin that engages a bearing opening of the free end and forcedly guides the free end of the guide arm.

31. The actuator according to claim 30, wherein the first and second eccentrics are arranged on opposite sides of the worm gear and are driven by the worm gear.

32. The actuator according to claim 30, wherein the first and second eccentrics are staggered in an axial direction of the worm gear on one side of the worm gear and are driven by the worm gear.

33. The actuator according to claim 32, wherein the guide arm extends in two oppositely oriented radial directions and has a first free end and a second free end opposite one another, wherein the guide arm is arranged between the first and second eccentrics and the first free end interacts with the first eccentric and the second free end interacts with the second eccentric and the first and second free ends are forcibly guided on the first and second eccentrics.

34. The actuator according to claim 33, further comprising a second wobble plate and a second driven wheel driven by the second wobble plate, wherein the first wobble plate is arranged on the first end and the second wobble plate is arranged on the second end.

35. The actuator according to claim 23, wherein the first eccentric is rotatably supported on a continuous axle bolt, wherein a diameter of the bearing pin is sized such that the axle bolt is located within a circumferential contour of the bearing pin.

36. The actuator according to claim 35, wherein the bearing pin is a unitary part of the first eccentric and is comprised of self-lubricating plastic material, wherein the bearing pin has a metal insert arranged in an area of the bearing pin that is oriented in the direction of eccentricity and is supported on the axle bolt.

37. The actuator according to claim 35, wherein the first driven wheel is supported together with the first eccentric on the axle bolt.

38. The actuator according to claim 37, wherein the first driven wheel has an external bearing surface that rotatably supports the first driven wheel in the housing.

39. The actuator according to claim 38, wherein the first wobble plate has an integrally formed gear wheel that is formed by stamping a metal blank.

40. The actuator according to claim 22, further comprising fastening screws that penetrate the housing of the reduction gear across at least approximately an entire thickness of the housing, wherein the fastening screws are provided for screwing the housing to a component to be driven by the actuator.

41. The actuator according to claim 40 wherein the housing is comprised of a bottom part and a cover part, wherein the fastening screws extend through the bottom part and the cover part.

42. The actuator according to claim 40, wherein at least two of the fastening screws are arranged on a line that is positioned at an angle of at least approximately 45° to an axis of rotation of the drive motor or of a drive worm of the drive motor, wherein the first driven wheel is preferably positioned between said at least two fastening screws.
